(19) United States
(12) Patent Application Publication
(10) Pub. No.: US 2026/0236464 A1
(43) Pub. Date: Aug. 13, 2026

(54) INFERENCE BATCHING FOR GENERATIVE NEURAL NETWORKS

(71) Applicant: GDM Holding LLC, Mountain View, CA (US)

(72) Inventors: Florian Nils Hartmann, Zurich (CH); Duc-Hieu Tran, Zurich (CH)

(21) Appl. No.: 19/051,057

(22) Filed: Feb. 11, 2025

(51) Int. Cl. G06F 16/2453; G06N 3/0475

(52) U.S. Cl. CPC G06F 16/2453; G06N 3/0475

(57) ABSTRACT

Methods, systems, and apparatus for inference batching in a generative neural network. In one aspect, a queue of candidate queries to a generative neural network is maintained. The candidate queries include one or more predicted queries that are predicted to be submitted by a user to the generative neural network at a future time. A query is received from the user. In response to receiving the query, a batch of queries is generated. The batch of queries includes the query and one or more other queries selected from the queue. The batch of queries is processed using the generative neural network to obtain a response to the query and a respective response to each of the other queries. Respective responses to one or more of the other queries are added to a datastore and the response to the query is returned to the user.

### BACKGROUND

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

Generative neural networks are machine learning models are configured, through training, to perform a generative task to generate, as output, data that includes, for example, text data, image data, video data, audio data, or multimodal data that includes data in two or more different modalities. Example generative tasks include text generation, image synthesis, audio generation, video generation, code generation, or style transfer.

### SUMMARY

This specification describes systems and methods directed to inference batching for generative neural networks, e.g., AI assistants.

In general, one innovative aspect of the subject matter described in this specification may be embodied in methods that include the actions of maintaining a queue of candidate queries to a generative neural network, the candidate queries comprising one or more predicted queries that are predicted to be submitted by a user to the generative neural network at a future time;

receiving a query from the user; generating, in response to receiving the query, a batch of queries, wherein the batch of queries comprises the query and one or more other queries selected from the queue; processing the batch of queries using the generative neural network to obtain a response to the query and a respective response to each of the other queries; adding respective responses to one or more of the other queries to a datastore; and returning the response to the query to the user.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other embodiments can each optionally include one or more of the following features, alone or in combination. In some implementations the queue of candidate queries further comprises scheduled queries that are received from the user and have a future deadline timestamp.

In some implementations queries in the queue are ordered according to respective query deadline timestamps.

In some implementations the queries in the queue are ordered using a machine learning model that is configured, through training, to predict an optimal query prioritization using training data comprising one or more of: data recording how often the user asks a query and a time at which the user asks the query, a current time, or a current backlog of scheduled queries. In some implementations the method further comprises terminating the processing of the batch of queries using the generative neural network in response to obtaining a complete response to the query, wherein the respective responses to the one or more other queries that are added to the datastore comprise complete responses; and returning other queries with partial responses generated during the processing of the batch of queries to the queue with the partial responses.

In some implementations the method further comprises adding, during the processing of the batch of queries and prior to terminating the processing of the batch, the complete responses to the one or more other queries to the datastore; and adding, during the processing of the batch and prior to terminating the processing of the batch, new scheduled or predicted queries to the batch to maintain batch size.

In some implementations generating the batch of queries comprises: selecting one or more queries from the queue with a same or shorter length as the query; and padding selected queries with a shorter length than the query such that each query in the batch of queries has a same length.

In some implementations the batch of queries has a predetermined maximum batch size, the predetermined maximum batch size dependent on at least one of: a size of the generative neural network or hardware capabilities.

In some implementations the method further comprises generating one or more predicted queries, comprising: training a machine learning model on training data to predict future queries from previously submitted queries wherein the training data comprises proxy data, user-rated data, or live traffic data; and using the trained machine learning model to generate the one or more predicted queries; and adding the generated one or more predicted queries as predicted queries with respective predicted deadline timestamps to the queue.

In some implementations the generative neural network is implemented on a user device. In some implementations the generative neural network comprises a secure generative neural network implemented by a third party.

In some implementations the method further comprises receiving, from the user, a scheduled query; and adding the scheduled query as a predetermined scheduled query with a respective scheduled deadline timestamp to the queue.

In some implementations the method further comprises, in response to adding the scheduled query as a predetermined scheduled query to the queue or in response to adding one or more predicted queries as predetermined predicted queries to the queue, updating a priority order of the queries in the queue.

In some implementations the method further comprises determining, at periodic intervals, whether responses to scheduled or predicted queries stored in the datastore are valid, comprising monitoring data collected by applications or APIs on a device of the user; and in response to determining that one or more responses to scheduled or predicted queries stored in the datastore are invalid, returning the scheduled or predicted queries to the queue.

In some implementations the method further comprises returning a response to a scheduled query stored in the datastore to the user at a scheduled time.

In some implementations the method further comprises determining whether the query is similar to a scheduled or predicted query with a response that is stored in the datastore; and in response to determining that the query is similar to a scheduled or predicted query with a response that is stored in the datastore, returning the response stored in the datastore to the user; or in response to determining that the query is dissimilar to a scheduled or predicted query with a response that is stored in the datastore, generating the batch of queries.

In some implementations determining whether the query is similar to a scheduled or predicted query comprises, for each scheduled or predicted query included in the datastore: determining whether a distance between the query and the scheduled or predicted query is less than a predetermined maximum distance and determining whether deadline timestamps for the query and the scheduled or predicted query are within a predetermined maximum difference.

In some implementations processing the batch of queries using the generative neural network to obtain the response to the query comprises batching feed-forward operations and performing attention for each element in the batch individually.

Some implementations of the subject matter described herein may realize, in certain instances, one or more of the following advantages.

Performing inference using generative neural networks, e.g., large language models, can be expensive because of the size of the underlying generative neural network. For server-side inference, the generative neural network will typically receive a constant supply of queries. The queries can therefore be batched without increasing latency. Example batching techniques include, e.g., continuous batching.

However, some generative neural networks may not receive a constant supply of queries. For example, the generative neural network may be part of a personal AI assistant system that is only queried by a single user or an AI assistant system that is queried by a limited number of users, e.g., part of a smart home application that is queried by multiple family members. As another example, the generative neural network may be deployed by a particular business or organization and only queried by multiple users that are associated with the business or organization. As another example, the generative neural network may be securely implemented server-side (so that user data used during training and at inference remains private and secure) and queried by one or a small number of users. In these examples, queries are typically handled individually since inference batching can cause delays, e.g., whilst waiting to fill the batch.

The presently described systems and methods combine different types of user queries to enable inference batching for generative neural networks that do not receive a constant stream of user requests, e.g., local AI assistants that are implemented directly on a user device or AI assistants that perform secure server-side inference. Accordingly, examples of the presently described generative neural network systems and methods achieve a reduction in the computational cost of inference, since the cost of performing inference for a single query comes at (nearly) the same cost as performing inference for an entire batch. Further, the reduction in the cost of inference also results in improved energy efficiency, which is particularly beneficial for on-edge devices that run the local AI assistants. In addition, the AI assistant can achieve reduced latency when answering scheduled or ad-hoc user queries that are similar to previously predicted queries, since the responses to such queries need not be generated in real time as individual queries, but can be generated ahead of time and then retrieved from storage at the appropriate time.

Further, the presently described techniques are motivated by technical considerations of the internal functioning of computer systems that implement generative neural networks. Since generative neural networks process data based on matrix multiplication, they can be efficiently implemented using hardware accelerators that are optimized for parallel computations, e.g., GPUs, TPUs, or other hardware accelerators that perform matrix multiplication in hardware.

Running an inference pass with a single query (or even a small batch of queries) underutilizes the parallel processing capabilities of such a hardware accelerator. However, by combining different types of user queries as described herein, an inference pass can be run with a batch of queries in parallel, where the size of the batch can be selected to optimize utilization of the hardware accelerator. In other words, the presently described techniques leverage the ability of hardware accelerators that perform matrix multiplications to process computations in a batches of queries in parallel, and are therefore directed to a specific technical implementation.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a conceptual diagram of inference batching in an AI assistant.

FIG. 2 is a block diagram of an example AI assistant system that implements inference batching.

FIG. 3 is a block diagram of the AI assistant system of FIG. 2 during an example process for adding scheduled or predicted queries to the schedule and predicted queries datastore.

FIG. 4 is a block diagram of the AI assistant system of FIG. 2 during an example process for processing an ad-hoc user query.

FIG. 5 is a block diagram of the AI assistant system of FIG. 2 during an example process for monitoring the validity of responses to scheduled or predicted queries stored in the responses to scheduled or predicted queries datastore.

FIG. 6 is a flow chart of an example process for inference batching in an AI assistant.

Like reference symbols in the various drawings indicate like elements.

### DETAILED DESCRIPTION

This specification describes systems and methods for inference batching in generative neural networks, e.g., when used as part of AI assistant systems. Queries for which an entity expects a fast response are batched together with other queries that are scheduled by the entity and/or predicted a-priori by the generative neural network system. The generative neural network system processes the batch until responses to the queries are generated. The responses to the queries are returned to the entity. Responses to the other queries in the batch are stored and delivered to the entity at a later time, e.g., at a scheduled time or in response to future input of similar queries by the entity. The entity can be a single user or a collection of users.

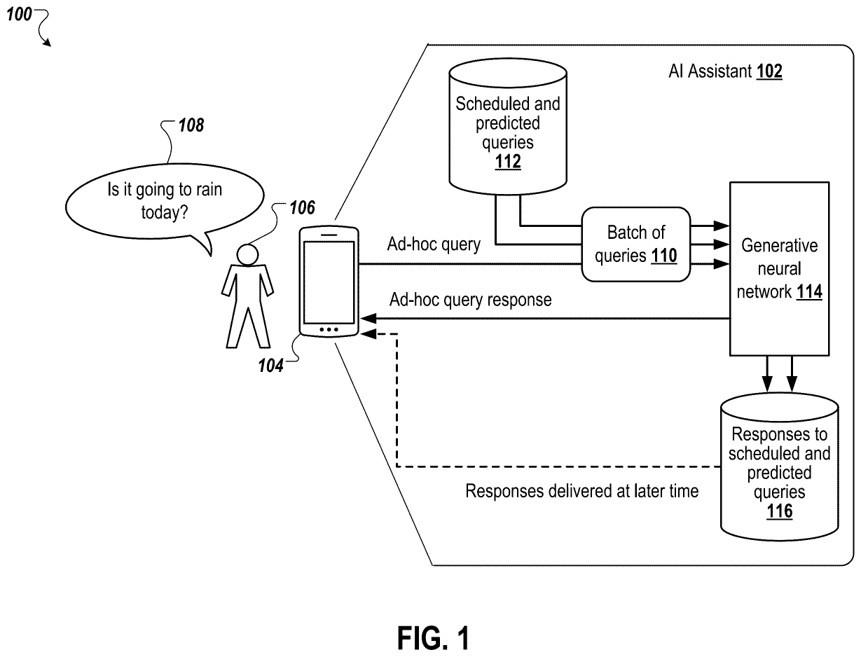

FIG. 1 is a conceptual diagram 100 of inference batching in a personal AI assistant system. An AI assistant system 102 operates on a user device 104. A user 106 of the user device 104 poses an ad-hoc query 108 to the AI assistant system 102, e.g., “is it going to rain today?” The ad-hoc query 108 is a query for which the user 106 expects a fast response. Therefore, in response to receiving the ad-hoc query, the AI assistant system 102 triggers an inference pass.

In conventional approaches, the AI assistant system could process the ad-hoc query using a generative neural network such as a large language model as a single query. However, running an inference pass with a single query typically underutilizes the parallel processing capabilities of the hardware implementing the generative neural network. Since generative neural networks process data based on matrix multiplication, the inference of batches of queries can be handled in parallel using GPUs, TPUs, or other hardware accelerators that perform matrix multiplication in hardware and, more specifically, can perform multiple individual multiplications between a set of inputs and a given weight tensor in parallel. Therefore, processing a single query incurs a similar computational cost as inferring an entire batch of queries, where the size of the batch is dependent on the specific hardware implementation since some hardware accelerators operate with a fixed batch size and/or have a corresponding batch size that optimizes utilization.

Alternatively, in conventional approaches, the AI assistant system could add the ad-hoc query to a batch and run the inference pass when the batch is full. However, in systems that receive queries sporadically, such batching introduces delays.

Therefore, instead of processing the ad-hoc query 108 individually or waiting to fill a batch of queries, the AI assistant system 102 generates a batch of queries 110 that includes the ad-hoc query 108 and one or more other queries selected from a datastore 112. The other queries include scheduled queries and predicted queries. Scheduled queries are queries posed by the user 106 for which the user 106 expects a response at a later time. An example scheduled query is a request from the user 106 that the AI assistant system 102 provide a summary of the user's meetings for the day at 8 am. Predicted queries are queries that the AI assistant system 102 infers the user 106 is likely to pose (as an ad-hoc query) at a later time. An example predicted query is a request for a summary of the top news stories on a coming Sunday morning at 10 am, which could be inferred by the AI assistant system 102 if the user 106 has historically posed this query as an ad-hoc query on preceding Sunday mornings.

The AI assistant system 102 then processes the batch of queries 110 using the generative neural network 114. Once a response to the ad-hoc query 108 has been generated, the AI assistant system 102 returns the response to the user 106. Responses to the one or more other queries in the batch 110 are stored in a datastore 116. Some of these responses can be returned to the user 106 at a later time, e.g., at a scheduled time or when the user 106 poses a new ad-hoc query that is similar to one of the other queries. Other responses stored in the datastore 116 may not be returned to the user 106, e.g., if the responses become invalid over time as described in more detail below.

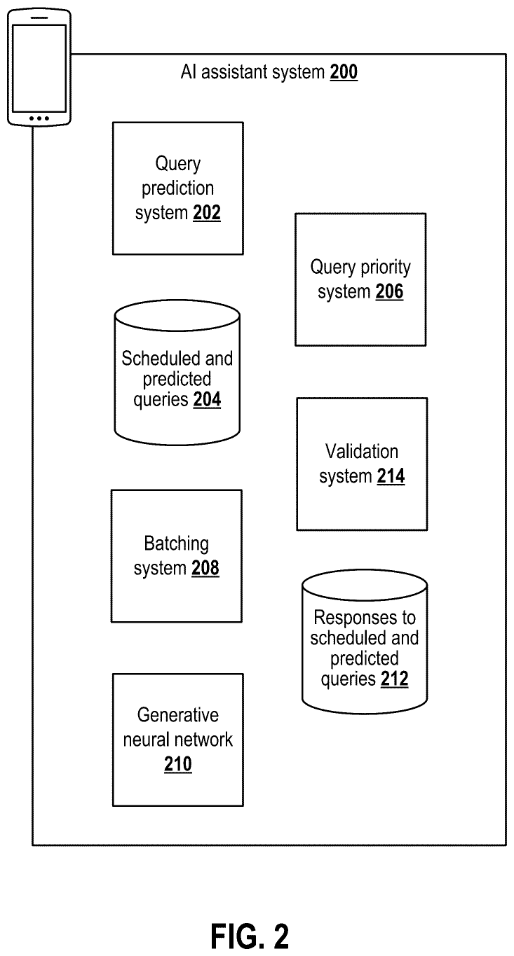

FIG. 2 is a block diagram of an example AI assistant system 200 that implements inference batching. The example AI assistant system 200 is an example of a system implemented as computer programs on one or more computers in one or more locations, in which the systems, components, and techniques described herein can be implemented. In the example shown in FIG. 2, the AI assistant system 200 is a local system that is implemented directly on a user device, e.g., a smartphone, tablet, or desktop, without requiring cloud connectivity.

The example AI assistant system 200 includes a query prediction system 202, a scheduled and predicted queries datastore 204, a query priority system 206, a batching system 208, a generative neural network 210, a responses to scheduled and predicted queries datastore 212, and a validation system 214. In some implementations the AI assistant system 200 can also include additional components not illustrated in FIG. 2, e.g., a user interface layer, natural language processing module, task management system, knowledge base, etc.

The query prediction system 202 is configured to generate predicted queries. As described above with reference to FIG. 1, predicted queries are queries that the AI assistant system 200 predicts a user is likely to pose (as an ad-hoc query) at a later time. In some implementations, the query prediction system 202 can be a machine learning model that receives an input that includes data specifying one or more of: a current date, a current location, current applications running on the user device, one or more prior queries asked by the user (and dates, locations, and applications that were running when the prior queries were submitted), as well as other information such as an amount of memory available to the system 200. The machine learning model is configured to process the received input to generate an output that predicts future ad-hoc queries that the user is likely to pose at a later time (and likely times at which the user would expect answers to the future ad-hoc queries).

The machine learning model can be configured to predict future ad-hoc queries using training data. In some implementations the training data can include proxy data or user-rated data. In other implementations the training data can include live traffic data and the training can incorporate ground truth data of ad-hoc queries provided to the system. This can be advantageous when the model is trained on-device, e.g., as part of federated or personalized training. In these implementations the ground truth for the output when a user submits an ad-hoc query to the system can be used as a feedback signal to train the machine learning model.

The predicted queries generated by the query prediction system 202 are stored in the scheduled and predicted queries datastore 204. Each predicted query is stored in the scheduled and predicted queries datastore 204 with a corresponding timestamp at which the user is predicted to expect a response to the query.

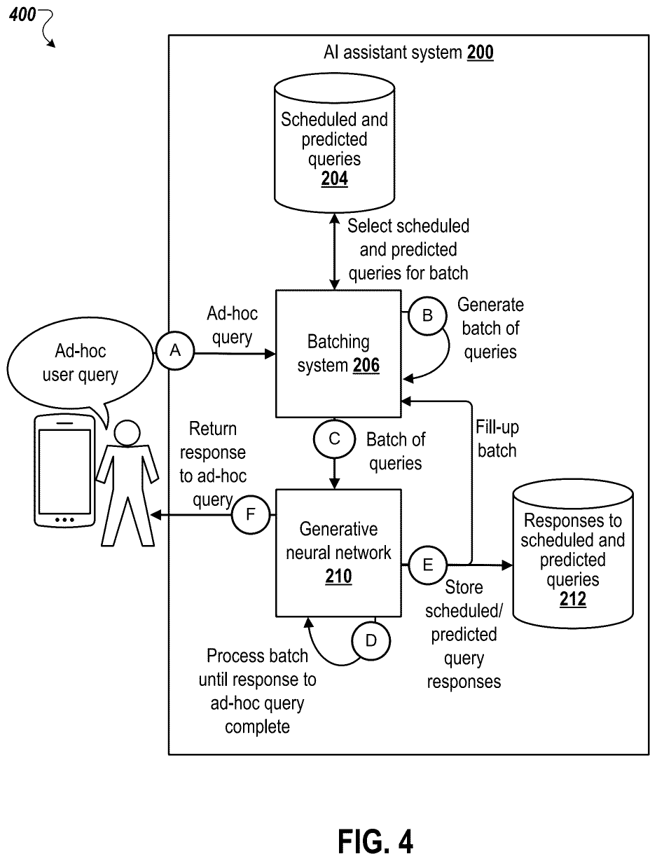

The scheduled and predicted queries datastore 204 is also configured to store scheduled queries received from the user. For example, in some implementations the AI assistant system 200 can include a user interface that enables a user to schedule (potentially repeatedly) future queries to the AI assistant system at respective times. In other implementations the AI assistant system 200 can be configured to extract queries and corresponding delivery times from a natural language input provided by the user. Each scheduled query is also stored with a corresponding timestamp at which the user has requested a response to the query. For example, the scheduled and predicted queries stored in the scheduled and predicted queries datastore 204 can be stored as a queue of (query, deadline timestamp) pairs. The scheduled and predicted queries datastore 204 can also store partial responses to the scheduled and predicted queries, e.g., partial responses generated by the generative neural network 210 as described in more detail below with reference to FIG. 4.

The query priority system 206 is configured to determine an order for the scheduled and predicted queries stored in the scheduled and predicted queries datastore 204. In some implementations the query priority system 206 can order the scheduled and predicted queries according to the deadline timestamps, e.g., where a most urgent query (a query with a timestamp that is the closest to a current time) is stored at the top of the queue. In other implementations the query priority system 206 can order the scheduled and predicted queries according to the deadline timestamps and additional priority criteria. For example, the query priority system 206 can determine to prioritize scheduled queries over predicted queries, since scheduled queries are posed by the user and their responses are guaranteed to be delivered to the user at the scheduled time. As another example, the query priority system 206 can determine to order the scheduled and predicted queries according to the deadline timestamps and predicted likelihoods that a user will ask the predicted queries generated by the query prediction system 202.

In other implementations the query priority system 206 can apply a more systematic approach to determine an order for the scheduled and predicted queries. For example, the query priority system 206 can be configured to maintain a histogram of how often, and at which times, the user asks an ad-hoc query. The query priority system 206 can then train a local machine learning model using the histogram as well as a current time and backlog of scheduled queries to predict an optimal ordering for the scheduled and predicted queries stored in the scheduled and predicted queries datastore 204, e.g., an ordering that balances the number of scheduled queries and predicted queries included in a top number of entries in the queue.

In more detail, the local machine learning model can be trained to predict how many scheduled queries and how many predicted queries to include in the queue. As input, the local machine learning model can receive histogram data that represents how often (and at which times) a user asks ad-hoc queries. The histogram data enables the local machine learning model to determine how many queries to add to the queue. For example, if it is likely that the user will soon pose more ad-hoc queries, then it may be beneficial to wait before adding scheduled or predicted queries to the queue (e.g., to reduce the likelihood of outdated/invalid results). The local machine learning model can be trained by making a prediction and obtaining a reward based on a combination of: (i) whether later on all the scheduled queries were indeed answered with batching for free, (ii) whether it answered scheduled queries that later had to be invalidated, and (iii) how many predicted queries it on top managed to answer. These three factors can be combined in a linear combination with weights that are hyperparameters.

The batching system 208 is configured to generate a batch of queries in response to receiving an ad-hoc query input by a user of the user device. When an ad-hoc user query is received, the batching system 208 accesses the scheduled and predicted queries stored in the scheduled and predicted queries datastore 204 and selects one or more of the scheduled and predicted queries to include in the batch.

In some implementations, the number of queries selected by the batching system 208 depends on a predetermined batch size. The predetermined maximum batch size can depend on properties of the generative neural network 210 included in or used by the AI assistant system 200 and/or hardware capabilities of the user device, e.g., the generative neural network architecture and size and/or device memory availability and processing power. In some implementations the maximum batch size can vary, e.g., dependent on the length of the ad-hoc query (since processing longer inputs requires more memory, reducing the number of inputs that can fit in a batch) or a current memory capacity. Since the scheduled and predicted queries stored in the scheduled and predicted queries datastore 204 are stored as an ordered queue, the batching system 208 can select the scheduled or predicted queries from the top of the queue.

The batching system 208 is also configured to pre-process the generated batch of queries before the batch is passed to the generative neural network 210. For example, to improve computational efficiency the batching system 208 can be configured to pad selected queries (and in some cases the ad-hoc query) to have a same length. This is because the generative neural network 210 may operate on tensors with fixed dimensions. Therefore, without padding, queries with different lengths can result in irregular tensor shapes, which can mean that some operations such as matrix multiplication or attention calculations cannot be performed in parallel.

Alternatively, the batching system 208 can be configured to filter selected scheduled and predicted queries to have a same query length (or to be within a predetermined distance from a same query length), e.g., the length of the ad-hoc user query. The batching system 208 can also be configured to tokenize queries included in the batch before providing the batch to the generative neural network 210.

The generative neural network 210 is a machine learning model that has been configured, through training, to perform a generative task to generate, as output, data that includes, for example, text data, image data, video data, audio data, or multimodal data that includes data in two or more different modalities. In the example shown in FIG. 2, the generative neural network 210 is implemented directly on the user device. However, in other examples the generative neural network 210 can be securely implemented server-side (so that user data used during training and at inference remains private and secure).

In some implementations the generative neural network 210 is a language model that is configured to process an input query by analyzing its context and relationships between words or phrases included in the input. For example, the language model can be a large language model (LLM), e.g., a generative LLM or a fine-tuned/specialized LLM. By construction, the generative neural network 210 can process batches of inputs where computations on elements in the batch are performed simultaneously. For example, in operations such as feed-forward layers, the generative neural network 210 can execute matrix multiplications in parallel for each input in the batch (whereas attention is computed for each element individually).

Some examples of generative tasks that the generative neural network 210 can be configured to perform are given below.

In some cases, the generative neural network 210 can be configured to perform an image processing task, i.e., receive a user query that includes an image and to process the image to generate an output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the generative neural network 210 can be configured to perform an image generation task, where the input is a conditioning input and the output is a sequence of intensity value inputs for the pixels of an image.

In some cases, the task may be a neural machine translation task. For example, if the input to the generative neural network 210 is a sequence of text, e.g., a sequence of words, phrases, characters, or word pieces, in one language, the output generated by the generative neural network 210 may be a translation of the sequence of text into another language, i.e., a sequence of text in the other language that is a translation of the input sequence of text. The vocabulary for the input tokens may be words, word pieces or characters of the first language, and the vocabulary for the output tokens may be words, word pieces or characters of the other language. As a particular example, the task may be a multi-lingual machine translation task, where the generative neural network 210 is configured to translate between multiple different source language-target language pairs. In this example, the source language text may be augmented with an identifier that indicates the target language into which the generative neural network 210 should translate the source language text.

As another example, the task may be automatic code generation. For example the input tokens may represent words, word pieces or characters in a first natural language and the output tokens may represent instructions in a computer programming or markup language, or instructions for controlling an application program to perform a task, e.g., build a data item such as an image or web page.

As another example, the task may be an audio processing task. For example, if the input to the generative neural network 210 is a sequence representing a spoken utterance, the output generated by the generative neural network 210 may be a score for each of a set of pieces of text, each score representing an estimated likelihood that the piece of text is the correct transcript for the utterance. As another example, if the input to the generative neural network 210 is a sequence representing a spoken utterance, the output generated by the generative neural network 210 can indicate whether a particular word or phrase (“hotword”) was spoken in the utterance.

As another example, if the input to the generative neural network 210 is a sequence representing a spoken utterance, the output generated by the generative neural network 210 can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the output is a spectrogram, a waveform, or other data defining audio of the text being spoken in the natural language.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations, the generative neural network 210 is capable of receiving network inputs and generating network outputs for multiple different machine learning tasks.

Generally, two machine learning tasks are different if they have different desired outputs for the inputs received for the tasks.

In practice, for any of these examples, the task to be performed by the generative neural network 210 can be defined by (at least a part of) the network input, e.g., that is in the form of a user query or a request, received by the generative neural network 210. In other words, the generative neural network 210 will be able to perform any of these tasks when an appropriate query or request is received.

In some implementations, the generative neural network 210 can be referred to as an auto-regressive neural network when the generative neural network 210 auto-regressively generates an output sequence of tokens as the network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

As a particular example, the generative neural network 210 can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv:2204.02311; Rohan Anil, et al., Palm 2 technical report. arXiv preprint arXiv:2305.10403, 2023; and Gemini Team, et al., Gemini: a family of highly capable multimodal models. arXiv preprint arXiv:2312.11805 (2023).

For example, the generative neural network 210 may be a generative language mode neural network. Examples of generative language model neural networks include Sparrow (Glaese, et al., arXiv:2209.14375), Chinchilla (Hoffmann, et al., arXiv:2203.15556), and PaLM 2 (Anil, et al., arXiv:2305:10403).

As another example, the generative neural network 210 may be a multi-modal model neural network, e.g., a vision language model (VLM) neural network. Examples of multi-modal neural networks include Flamingo (Alayrac, et al., arXiv: 2204.14198), PaLI (Chen, et al., arXiv: 2209.06794), and PaLI-X (Chen, et al., arXiv: 2305.18565).

As another example, the generative neural network 210 may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia, et al., arXiv: 2205.11487) and Parti (Yu, et al., arXiv: 2206.10789).

The generative neural network 210 can include an input block, followed by one or more intermediate blocks, followed by an output block. The input block can receive an input to the student neural network.

The input block can include an embedding layer. The embedding layer includes parameters that represent elements of an embedding matrix which can be used to map each token in the vocabulary of tokens into a corresponding embedding of the token.

The one or more intermediate blocks can include one or more attention blocks, e.g., one or more local attention blocks, one or more global attention blocks, or both. A local attention block is a block that includes a local attention mechanism, while a global attention block is a block that includes a global attention mechanism.

The output block can generate an output of the generative neural network 210. For example, the output can include a score distribution, e.g., a probability distribution, over tokens in a vocabulary of tokens. The score distribution assigns a respective score, e.g., a respective probability, to each token in the vocabulary of tokens.

The output block can include a de-embedding layer. The de-embedding layer includes parameters that represent elements of a de-embedding matrix which can be used to map an embedding to a corresponding token in the vocabulary of tokens. In some implementations, the de-embedding matrix can be a transpose of the embedding matrix included in the input block, such that each parameter of the de-embedding matrix has a corresponding parameter in the embedding matrix.

The vocabulary of tokens can include any of a variety of tokens that represent text symbols or other symbols. For example, the vocabulary of tokens can include one or more of: characters, sub-words, words, punctuation marks, numbers, or other symbols that appear in a corpus of natural language text and/or computer code.

Additionally or alternatively, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

In some cases the generative neural network 210 can be implemented by a hardware accelerator that performs matrix multiplication in parallel (or, more generally, that performs multiple individual multiplications between a set of inputs and a given weight tensor in parallel). For example, the generative neural network 210 can be implemented by a GPU, TPU, or other hardware accelerator that performs matrix multiplication in hardware.

Outputs generated by the generative neural network 210 can be returned to the user of the user device, e.g., if the output is a complete response to an ad-hoc query provided by the user, or stored in the responses to scheduled and predicted queries datastore 212, e.g., if the outputs are complete responses to scheduled or predicted queries The complete responses to the scheduled and predicted queries can be stored in the responses to scheduled and predicted queries datastore 212 until the responses are delivered to the user of the user device, e.g., at the scheduled time or when a similar ad-hoc query is input by the user.

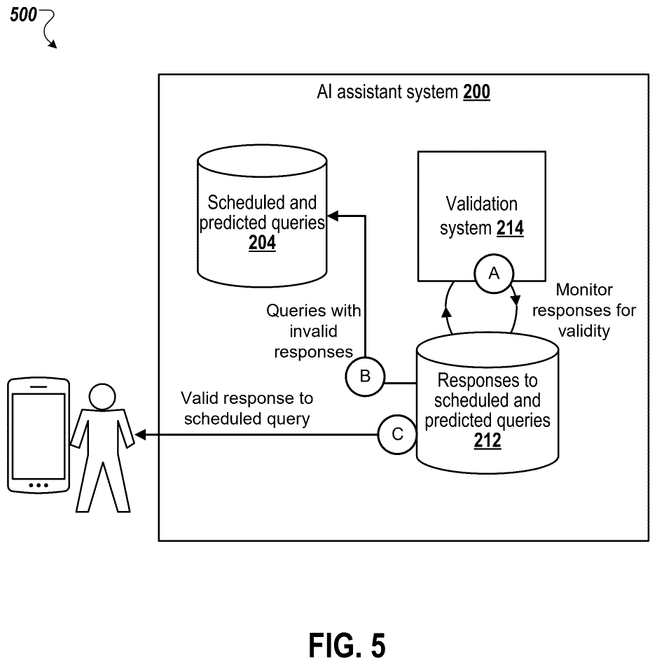

The validation system 214 is configured to monitor the validity of responses stored in the responses to scheduled and predicted queries datastore 212. For example, in some implementations a scheduled or predicted query might request a summary of the user's meetings be provided at 9am on Monday morning. In this example, if the user were to input an unrelated ad-hoc query at 830am, a response to the scheduled or predicted query could be generated with the response to the ad-hoc query at 830 am, and stored in the responses to scheduled and predicted queries datastore 212. However, if a new meeting invitation were to be sent to the user at 845 am, the response to the scheduled or predicted query would no longer be valid. In this example, the validation system 214 can be configured to detect the new meeting invitation and determine that the stored response to the scheduled or predicted query is no longer valid. The validation system 214 can then return the scheduled or predicted query to the scheduled and predicted queries datastore 204, e.g., to be processed in another batch some time before 9 am or as an ad-hoc query at 9 am. Example operations performed by the validation system 214 are described in more detail below with reference to FIG. 5.

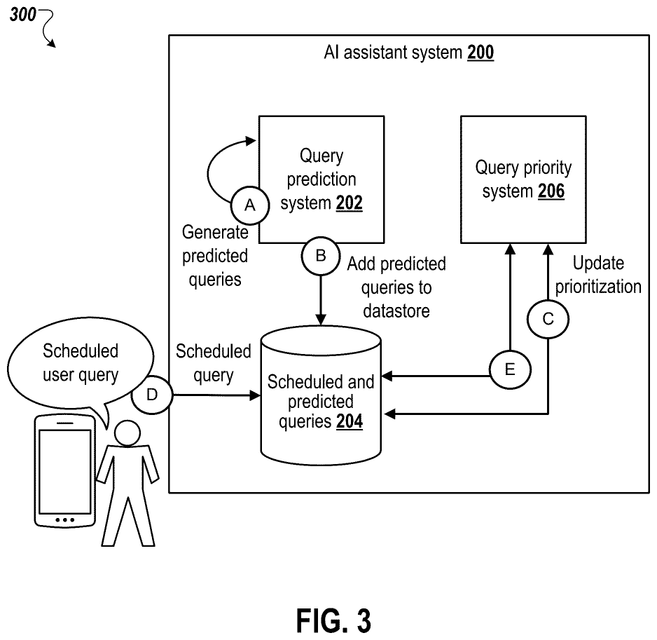

FIG. 3 is a block diagram 300 of the AI assistant system of FIG. 2 during an example process for adding scheduled or predicted queries to the schedule and predicted queries datastore 204. The block diagram 300 illustrates the example process as including stages (A)-(E).

However, in some implementations the process can include fewer or more stages. Further, in the example shown in FIG. 3, stages (D) and (E) follow stages (A)-(C), however in some implementations stages (D) and (E) can precede stages (A)-(C) or be performed approximately in parallel.

During stage (A) of the example process, the query prediction system 202 generates one or more predicted queries, e.g., using a trained machine learning model that has been configured, through training on training data, to predict future ad-hoc user queries as described above with reference to query prediction system 202. In some implementations the number of predicted queries generated by the query prediction system 202 during stage (A) can depend on the number of scheduled or predicted queries currently stored in the scheduled and predicted queries datastore 204. For example, the query prediction system 202 can generate a number of predicted queries to add to the scheduled and predicted queries datastore 204 such that the scheduled and predicted queries datastore 204 maintains a minimum number of query-deadline timestamp pairs. The minimum number can depend on a predetermined batch size used by the batching system 206. For example, the minimum number can be equal to the predetermined batch size.

During stage (B), the query prediction system 202 adds the generated one or more predicted queries to the scheduled and predicted queries datastore 204.

During stage (C), the query priority system detects that one or more queries have been added to the scheduled and predicted queries datastore 204 and updates the order of the scheduled and predicted queries stored in the scheduled and predicted queries datastore 204, e.g., according to the deadline timestamps and additional priority criteria described above.

During stage (D), the AI assistant system 200 receives a scheduled query from the user and adds the scheduled query to the scheduled and predicted queries datastore 204. In some implementations the AI assistant system 200, e.g., the validation system 214, can detect that a new query has been added to the scheduled and predicted queries datastore 204 and remove predicted queries from the scheduled and predicted queries datastore 204 that are similar to the scheduled query added during stage (D), so that the scheduled and predicted queries datastore 204 does not include multiple queries that request a similar task at a similar time. In this context, the two queries would be considered similar if a distance between the queries is within a predetermined threshold and also if the deadline timestamps of the queries are within a predetermined threshold from one another. For example, if a predicted query in the datastore 204 corresponds to a same task as the new query but has a different timestamp to the new scheduled query, the AI assistant system 200 may not remove the predicted query from the datastore 204. In some cases the distance between the queries can be computed based on a similarity between the queries, e.g., a Levenshtein distance. In other cases the distance between the queries can be computed in an embedding space. For example, the queries can be embedded in the embedding space, e.g., using a model that generates embeddings of inputs as fixed-dimensional vectors in an embedding space, and the distance between the embeddings can be computed, e.g., using a distance metric such as Euclidean distance or cosine similarity.

During stage (E), the query priority system again detects that one or more queries have been added to the scheduled and predicted queries datastore 204 and updates the order of the scheduled and predicted queries stored in the scheduled and predicted queries datastore 204, e.g., as described above with reference to stage (C).

FIG. 4 is a block diagram 400 of the AI assistant system of FIG. 2 during an example process for processing an ad-hoc user query. The block diagram 400 illustrates the example process as including stages (A)-(F). However, in some implementations the process can include fewer or more stages.

During stage (A) of the example process, the AI assistant system 200 receives an ad-hoc user query and provides the ad-hoc user query to the batching system 206. The batching system 206 determines whether the ad-hoc user query is similar to a scheduled or predicted query stored in the scheduled and predicted queries datastore 204 or a scheduled or predicted query for which a response has been generated and stored in the responses to scheduled and predicted queries datastore 212. For example, the batching system 206 can compute a distance, e.g., Levenshtein distance or a distance in an embedding space, between the ad-hoc user query and the scheduled or predicted queries in either datastore using a distance function, where two queries are similar if the computed distance is smaller than a predetermined threshold. If the batching system determines that a scheduled or predicted query in the responses to scheduled and predicted queries datastore 212 is similar to the ad-hoc user query, the batching system 206 can directly return the response to the scheduled or predicted query to the user.

During stage (B) of the example process, the batching system 206 generates a batch of queries. The batching system 206 initializes a batch using the ad-hoc user query and selects one or more scheduled or predicted queries from the scheduled and predicted queries datastore 204 to add to the initialized batch.

In implementations where the batching system 206 determines during stage (A) that a scheduled or predicted query in the scheduled and predicted queries datastore 204 is similar to the ad-hoc user query, the batching system 206 can exclude the similar query from the selected one or more scheduled or predicted queries, i.e., to avoid processing two similar queries in a same batch. The number of queries added to the initialized batch depends on a predetermined maximum batch size. For example, if the AI assistant with inference batching system 200 allows for a batch size of 8, the batching system 206 can configure a batch that includes the ad-hoc user query and 7 additional queries selected from the scheduled and predicted queries datastore 204. As described above with reference to FIG. 2, the scheduled and predicted queries stored in the scheduled and predicted queries datastore 204 are ordered according to a priority queue keyed by deadline timestamps. The batching system 206 uses this queue to select the one or more scheduled or predicted queries to include in the batch. For example, in some implementations the batching system 206 selects the one or more scheduled or predicted queries from the top of the queue. That is, the batching system 206 can select queries for which results are needed the soonest.

In other implementations, the batching system 206 can select the scheduled or predicted queries from the queue using one or more additional constraints. For example, the batching system 206 can select the scheduled or predicted queries based on both the deadline timestamps and the length of the ad-hoc query and/or the lengths of the scheduled or predicted queries in the priority queue. For example, the batching system 206 can select scheduled or predicted queries from queue with the additional constraint that the selected queries have the same length.

Alternatively, the batching system 206 can select scheduled or predicted queries from queue with the additional constraint that the selected queries have at most the same length as the ad-hoc user query. The batching system 206 can then pad the selected queries so that each query in the batch has the same length (the length of the ad-hoc query). This batching strategy can be advantageous since the padding of the selected scheduled or predicted queries has no effect on how quickly the ad-hoc user query is answered.

During stage (C) of the example process, the batching system 206 provides the generated batch to the generative neural network 210 for processing.

During stage (D) of the example process, the generative neural network 210 processes the batch of queries until a response to the ad-hoc user query received during stage (A) is completed. As described above with reference to FIG. 2, when processing the batch of queries, the generative neural network 210 can perform feed-forward operations approximately simultaneously for the entire batch and apply attention mechanisms, e.g., paged attention, individually to each input element.

In some implementations, the generative neural network 210 may complete responses to one or more of the scheduled or predicted queries included in the batch before the response to the ad-hoc user query received during stage (A) is completed. This is because the generative neural network 210 generates outputs autoregressively, i.e., the generative neural network 210 outputs one token at a time based on previously generated tokens. Since the output sequences for different input queries in the batch may have different lengths, shorter output sequences can be completed at earlier auto-regressive time steps, whilst longer sequences require more steps to reach completion. In these implementations, during stage (E), the AI assistant with inference batching system 200 can store the complete responses to the one or more of the scheduled or predicted queries included in the batch in the responses to scheduled and predicted queries datastore 212. The batching system 206 can then select additional predicted or scheduled queries from the scheduled and predicted queries datastore 204 to replace the completed one or more the scheduled or predicted queries in the batch, i.e., fill up the batch, and provide the additional predicted or scheduled queries to the generative neural network 210 for processing.

During stage (F), when the generative neural network 210 completes the response to the ad-hoc user query, the AI assistant with inference batching system 200 returns the completed response to the ad-hoc user query to the user. For example, the response to the ad-hoc user query can be displayed to the user as a text response or transformed by the AI assistant into spoken words using text-to-speech conversion.

In some implementations, the generative neural network 210 terminates processing the batch generated during stage (B) when the response to the ad-hoc user query received during stage (A) is completed. Because the generative neural network 210 generates outputs autoregressively, as described above, this means that some of the predicted and scheduled queries included in the batch may not be fully answered before the processing is terminated (i.e., predicted and scheduled queries that have output sequences that are longer than the output sequence for the ad-hoc user query will not be fully answered). The AI assistant with inference batching system 200 can then add the predicted and scheduled queries that were not fully answered during the processing of the batch at stage (D) (and the corresponding partial/incomplete responses generated during stage (D)) to the priority queue in the scheduled and predicted queries datastore 204 for processing to completion at a later time, e.g., in a new batch or at a scheduled time. In other implementations, the AI assistant with inference batching system 200 can determine to continue the processing of the batch generated during stage (B) when the response to the ad-hoc user query received during stage (A) is completed. For example, when the response to the ad-hoc user query received during stage (A) is completed, the AI assistant with inference batching system 200 can predict completion times of the partially answered scheduled and predicted queries. The system can predict a completion time of a partially answered query based on a known maximum number of decoding steps that can bet used to determine a number of remaining decoding steps or via a heuristic, e.g., if the user requested for a specific number of tokens or if a particular task always produces a fixed number of tokens. The system can use the number of remaining tokens to decode to estimate the remaining completion time.

If the predicted completion times are less than a predetermined acceptable threshold, the AI assistant with inference batching system 200 can cause the generative neural network 210 to continue processing the partially answered scheduled and predicted queries until completion.

The completed responses can then be stored in the responses to scheduled and predicted queries datastore 212.

FIG. 5 is a block diagram 500 of the AI assistant system of FIG. 2 during an example process for monitoring the validity of responses to scheduled or predicted queries stored in the responses to scheduled or predicted queries datastore 212. The block diagram 300 illustrates the example process as including stages (A)-(C). However, in some implementations the process can include fewer or more stages.

As described above, the responses stored in the scheduled and predicted queries datastore 212 are responses that are to be delivered at a later time, i.e., a scheduled or predicted time.

However, in some implementations, a stored response to a scheduled or predicted query can become invalid before it is delivered at the scheduled or predicted time. For example, a user of the user device could request that the AI assistant provide them with a daily meeting summary at 8 am each morning. If the corresponding scheduled query is added to a batch before 8 am, e.g., at 7 am, the response to the scheduled query could become invalid between the time at which the response is generated and the scheduled time the response should be delivered, e.g., if a new meeting invitation comes in a 730 am.

Therefore, during stage (A) of the example process, the validation system 214 monitors data collected from the user device, e.g., data from applications on the user device such as a user calendar or data from connected APIs such as weather or news services, to determine whether responses to scheduled or predicted queries stored in the responses to scheduled or predicted queries datastore 212 are valid or invalid. For example, the validation system can use chain of thought reasoning about whether the information is valid or not, use a contextual signal (e.g., a weather report from yesterday would clearly be based on an outdated API call), or feedback from the user indicating that the responses are invalid/outdated.

During stage (B), the scheduled or predicted queries with invalid responses are returned to the scheduled and predicted queries datastore 204, e.g., to be batched with another ad-hoc user query or processed as an ad-hoc query at a scheduled time. During stage (C), scheduled queries with valid responses are delivered at the corresponding scheduled time.

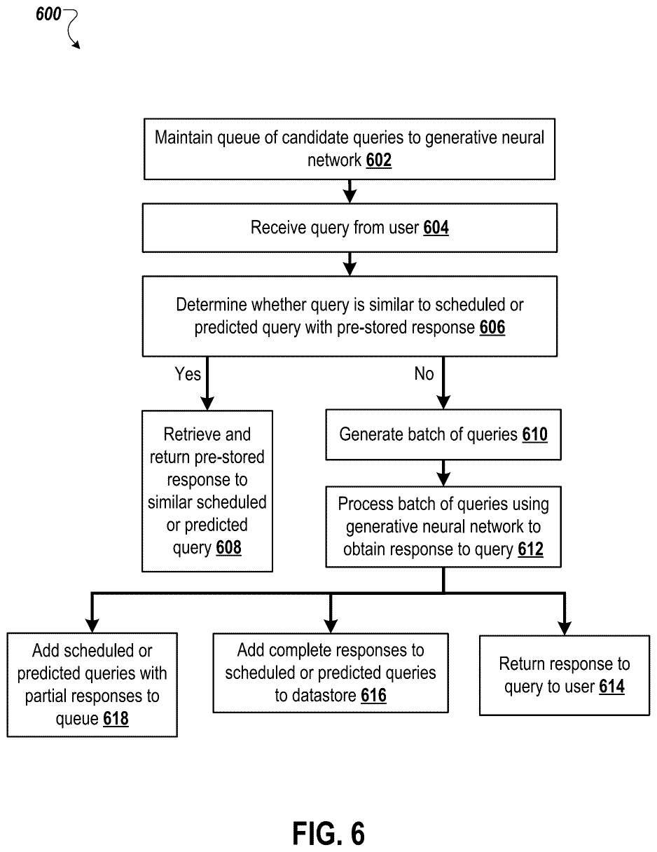

FIG. 6 is a flow chart of an example process 600 for inference batching in an AI assistant. For convenience, the process 600 will be described as being performed by a system of one or more computers located in one or more locations. For example, an AI assistant system, e.g., the AI assistant system 200 of FIG. 2, appropriately programmed, can perform example process 600. The system maintains a queue of candidate queries to a generative neural network (step 602). The candidate queries include one or more predicted queries that are predicted to be submitted by a user to the generative neural network at a future time and have respective future deadline timestamps (predicted timestamps). In some implementations the system can use a first machine learning model to generate predicted queries, e.g., a machine learning model that has been trained on training data to predict future ad-hoc queries from previously submitted ad-hoc queries. The training data can include proxy data, user-rated data, or live traffic data. When the system generates a predicted query, the system can add the predicted query and its deadline timestamp to the queue as a predetermined predicted query.

The candidate queries can also include one or more scheduled queries. A scheduled query is a query that is received from a user and has a future deadline timestamp (a scheduled timestamp). When the system receives a scheduled query from the user, the system can add the scheduled query and its deadline timestamp to the queue as a predetermined scheduled query.

In some implementations, the system can order the candidate queries in the queue according to respective query deadline timestamps, e.g., with a most urgent query at the top of the queue. In other implementations the system can order the candidate queries using a second machine learning model that has been trained to predict an optimal query prioritization using training data. In these implementations, the training data can include one or more of: data recording how often the user asks an ad-hoc query and a time at which the user asks the ad-hoc query, a current time (at which the machine learning model is used to determine an ordering for the queries in the queue, e.g., in response to one or more new queries being added to the queue), or a current backlog of scheduled queries. The ordering can be updated each time a new scheduled or predicted query is added to the queue.

The system receives a query from a user (step 604). In some implementations the system can determine whether the query is similar to a scheduled or predicted query with a response that has already been generated and is stored in a datastore (step 606). For example, the system can determine whether a distance between the query and each scheduled or predicted query included in the datastore is less than a predetermined maximum distance and determine whether deadline timestamps for the query and the scheduled or predicted query are within a predetermined maximum difference. In response to determining that the query is similar to a scheduled or predicted query with a response that is stored in the datastore, the system can retrieve and return the response to the user, without performing an inference pass using the generative neural network (step 608).

In response to determining that the query is not similar to the scheduled and predicted queries stored in the datastore, the system generates a batch of queries (step 610). The batch of queries includes the query and one or more other queries selected from the queue of candidate queries, e.g., selected from the top of the queue. The number of other queries included in the batch is dependent on the size of the batch. In some implementations, the batch can have a predetermined maximum batch size, e.g., where the predetermined maximum batch size is dependent on at least one of: a size of the generative neural network or hardware capabilities of the user's device. In some implementations, each query in the batch can have a same length.

For example, in some implementations the system can select queries from the queue that have a same or shorter length as the query. The system can then pad selected queries with a shorter length than the query such that each query in the batch of queries has a same length.

The system processes the batch of queries using the generative neural network to obtain a response to the query (step 612). In some implementations the generative neural network can batch feedforward operations and perform attention for elements in the batch individually. The system returns the response to the query to the user (step 614).

In some implementations the system can terminate the processing of the batch of queries when a complete response to the query is obtained. In these implementations, complete responses to other queries in the batch that were generated during the processing are added to the datastore described above with reference to step 604, e.g., to be returned to the user at a scheduled time or in response to receiving a similar query (step 616). In some implementations the system can monitor stored responses to scheduled or predicted queries, e.g., at regular time intervals, to determine that the stored responses are still valid, e.g., using data collected by applications or APIs on the user's device. In response to determining that one or more stored responses are invalid, the system can return the corresponding scheduled or predicted queries to the queue described at step 602.

In some implementations, when a complete response is added to the datastore, the system can select a new query from the queue of candidate queries to add to the batch, i.e., to fill the batch and maintain batch size whilst the batch is still being processed. Partial responses to other queries in the batch that were generated during the processing can be returned (with the corresponding queries) to the queue to be processed in a subsequent batch or as a new query (step 618).

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks.

However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

1. A computer implemented method comprising:
storing, in a queue, candidate queries to a generative neural network, the candidate queries comprising one or more predicted queries that are predicted to be submitted by a user to the generative neural network at a future time;
receiving a query from the user;
generating, in response to receiving the query, a batch of queries, wherein the batch of queries comprises the query and one or more other queries selected from the queue, the one or more other queries comprising at least one predicted query;
processing the batch of queries using the generative neural network to obtain a response to the query and a respective response to each of the other queries;
adding respective responses to one or more of the other queries to a datastore; returning the response to the query to the user; and
returning, from the datastore, one or more responses to queries stored in the datastore to the user at scheduled times or in response to future inputs of similar queries.

2. The method of claim 1, wherein the queue of candidate queries further comprises scheduled queries that are received from the user and have a future deadline timestamp.

3. The method of claim 1, wherein queries in the queue are ordered according to respective query deadline timestamps.

4. The method of claim 3, wherein the queries in the queue are ordered using a machine learning model that is configured, through training, to predict an optimal query prioritization using training data comprising one or more of: data recording how often the user asks a query and a time at which the user asks the query, a current time, or a current backlog of scheduled queries.

5. The method of claim 1, further comprising:
terminating the processing of the batch of queries using the generative neural network in response to obtaining a complete response to the query, wherein the respective responses to the one or more other queries that are added to the datastore comprise complete responses; and
returning other queries with partial responses generated during the processing of the batch of queries to the queue with the partial responses.

6. The method of claim 5, further comprising:
adding, during the processing of the batch of queries and prior to terminating the processing of the batch, the complete responses to the one or more other queries to the datastore; and
adding, during the processing of the batch and prior to terminating the processing of the batch, new scheduled or predicted queries to the batch to maintain batch size.

7. The method of claim 1, wherein generating the batch of queries comprises:
selecting one or more queries from the queue with a same or shorter length as the query; and
padding selected queries with a shorter length than the query such that each query in the batch of queries has a same length.

8. The method of claim 1, wherein the batch of queries has a predetermined maximum batch size, the predetermined maximum batch size dependent on at least one of: a size of the generative neural network or hardware capabilities.

9. The method of claim 1, further comprising:
generating one or more predicted queries, comprising:
training a machine learning model on training data to predict future queries from previously submitted queries wherein the training data comprises proxy data, user-rated data, or live traffic data; and
using the trained machine learning model to generate the one or more predicted queries; and
adding the generated one or more predicted queries as predicted queries with respective predicted deadline timestamps to the queue.

10. The method of claim 1, wherein the generative neural network is implemented on a user device.

11. The method of claim 1, wherein the generative neural network comprises a secure generative neural network implemented by a third party.

12. The method of claim 1, further comprising:
receiving, from the user, a scheduled query; and
adding the scheduled query as a predetermined scheduled query with a respective scheduled deadline timestamp to the queue.

13. The method of claim 12, further comprising, in response to adding the scheduled query as a predetermined scheduled query to the queue or in response to adding one or more predicted queries as predetermined predicted queries to the queue, updating a priority order of the queries in the queue.

14. The method of claim 1, further comprising:
determining, at periodic intervals, whether responses to scheduled or predicted queries stored in the datastore are valid, comprising monitoring data collected by applications or APIs on a device of the user; and
in response to determining that one or more responses to scheduled or predicted queries stored in the datastore are invalid, returning the scheduled or predicted queries to the queue.

15. The method of claim 1, further comprising:
returning a response to a scheduled query stored in the datastore to the user at a scheduled time.

16. The method of claim 1, further comprising:
determining whether the query is similar to a scheduled or predicted query with a response that is stored in the datastore; and
in response to determining that the query is similar to a scheduled or predicted query with a response that is stored in the datastore, returning the response stored in the datastore to the user; or
in response to determining that the query is dissimilar to a scheduled or predicted query with a response that is stored in the datastore, generating the batch of queries.

17. The method of claim 16, wherein determining whether the query is similar to a scheduled or predicted query comprises, for each scheduled or predicted query included in the datastore:
determining whether a distance between the query and the scheduled or predicted query is less than a predetermined maximum distance and determining whether deadline timestamps for the query and the scheduled or predicted query are within a predetermined maximum difference.

18. The method of claim 1, wherein processing the batch of queries using the generative neural network to obtain the response to the query comprises batching feed-forward operations and performing attention for each element in the batch individually.

19. A system comprising one or more computers and one or more storage devices storing instructions that are operable, when executed by the one or more computers, to cause the one or more computers to perform operations comprising:
storing, in a queue, candidate queries to a generative neural network, the candidate queries comprising one or more predicted queries that are predicted to be submitted by a user to the generative neural network at a future time;
receiving a query from the user;
generating, in response to receiving the query, a batch of queries, wherein the batch of queries comprises the query and one or more other queries selected from the queue, the one or more other queries comprising at least one predicted query;
processing the batch of queries using the generative neural network to obtain a response to the query and a respective response to each of the other queries;
adding respective responses to one or more of the other queries to a datastore;
returning the response to the query to the user; and
returning, from the datastore, one or more responses to queries stored in the datastore to the user at scheduled times or in response to future inputs of similar queries.

20. One or more computer storage media encoded with instructions that, when executed by one or more computers, cause the one or more computers to perform operations comprising:
storing, in a queue, candidate queries to a generative neural network, the candidate queries comprising one or more predicted queries that are predicted to be submitted by a user to the generative neural network at a future time;
receiving a query from the user;
generating, in response to receiving the query, a batch of queries, wherein the batch of queries comprises the query and one or more other queries selected from the queue, the one or more other queries comprising at least one predicted query;
processing the batch of queries using the generative neural network to obtain a response to the query and a respective response to each of the other queries;
adding respective responses to one or more of the other queries to a datastore;
returning the response to the query to the user; and
returning, from the datastore, one or more responses to queries stored in the datastore to the user at scheduled times or in response to future inputs of similar queries.
